(19) United States
(12) Patent Application Publication
(10) Pub. No.: US 2026/0080539 A1
(43) Pub. Date: Mar. 19, 2026

(54) INFORMATION PROCESSING DEVICE, ULTRASONIC DIAGNOSTIC DEVICE, INFORMATION PROCESSING METHOD, AND NON-TRANSITORY COMPUTER READABLE MEDIUM

(71) Applicant: CANON MEDICAL SYSTEMS CORPORATION, Tochigi (JP)

(72) Inventors: Masashi USUMURA, Nasushiobara (JP); Hiroki TAKAHASHI, Nasushiobara (JP)

(73) Assignee: CANON MEDICAL SYSTEMS CORPORATION, Tochigi (JP)

(21) Appl. No.: 19/327,603

(22) Filed: Sep. 12, 2025

(30) Foreign Application Priority Data
Sep. 13, 2024 (JP) 2024-159338

(51) Int. Cl. G06T 7/00; G06T 7/11; G06T 7/136; G06T 11/00; G06V 10/764; G06V 20/70

(52) U.S. Cl. CPC G06T 7/0014; G06T 7/11; G06T 7/136; G06T 11/10; G06V 10/764; G06V 20/70; G06T 2207/10024; G06T 2207/10132; G06T 2207/20056; G06T 2207/30104

(57) ABSTRACT

An information processing device according to an embodiment includes a processing circuit. The processing circuit generates second data that is a data array classified by basis information by performing transform processing on first data, generates third data including a plurality of pieces of data by performing segmentation processing on the second data classified by the basis information, and generates fourth data by combining the pieces of data in the third data.

### CROSS-REFERENCE TO RELATED APPLICATIONS

This application is based upon and claims the benefit of priority from Japanese Patent Application No. 2024-159338, filed on Sep. 13, 2024; the entire contents of which are incorporated herein by reference.

### FIELD

Embodiments disclosed herein relate generally to an information processing device, an ultrasonic diagnostic device, an information processing method, and a non-transitory computer readable medium.

### BACKGROUND

In ultrasonic diagnostic devices, a quantitative value representing structural information of blood vessels may be calculated. For example, to calculate the quantitative value representing structural information of blood vessels, a binary image is generated from signals obtained by ultrasonic transmission/reception, and a quantitative value is calculated from the generated binary image.

However, if there is a luminance variation in an image, it is not possible to appropriately determine the threshold value for binarization. Hence, the accuracy of binarization may be reduced.

### BRIEF DESCRIPTION OF THE DRAWINGS

FIG. 1 is a diagram illustrating an example of a configuration of an ultrasonic diagnostic device according to an embodiment;

FIG. 2 is a flowchart for explaining a processing flow of an information processing device according to the embodiment;

FIG. 3 is a diagram for explaining the processing flow of the information processing device according to the embodiment;

FIG. 4 is a diagram for explaining data used for verifying an information processing method according to the embodiment;

FIG. 5 is a diagram illustrating an example of an output result by the information processing device according to the embodiment;

FIG. 6 is diagrams illustrating output results according to a comparative example;

FIG. 7 is a diagram illustrating an example of a frame addition signal that is a first comparative example;

FIG. 8 is a diagram illustrating an example of an output image in which binarization processing using an adaptive threshold is performed on the frame addition signal that is a second comparative example;

FIG. 9 is a diagram illustrating an example of an output image of the information processing device according to the embodiment;

FIG. 10 is a diagram illustrating an example of a monochrome output image output by the information processing device according to the embodiment; and

FIG. 11 is a diagram illustrating an example of a color output image output by the information processing device according to the embodiment.

### DETAILED DESCRIPTION

An information processing device according to an embodiment includes a processing circuit. The processing circuit generates second data that is a data array classified by basis information by performing transform processing on first data, generates third data including a plurality of pieces of data by performing segmentation processing on the second data classified by the basis information, and generates fourth data by combining the pieces of data in the third data.

Hereinafter, with reference to the accompanying drawings, an embodiment of an information processing device, an ultrasonic diagnostic device, an information processing method, and a non-transitory computer readable medium will be described in detail.

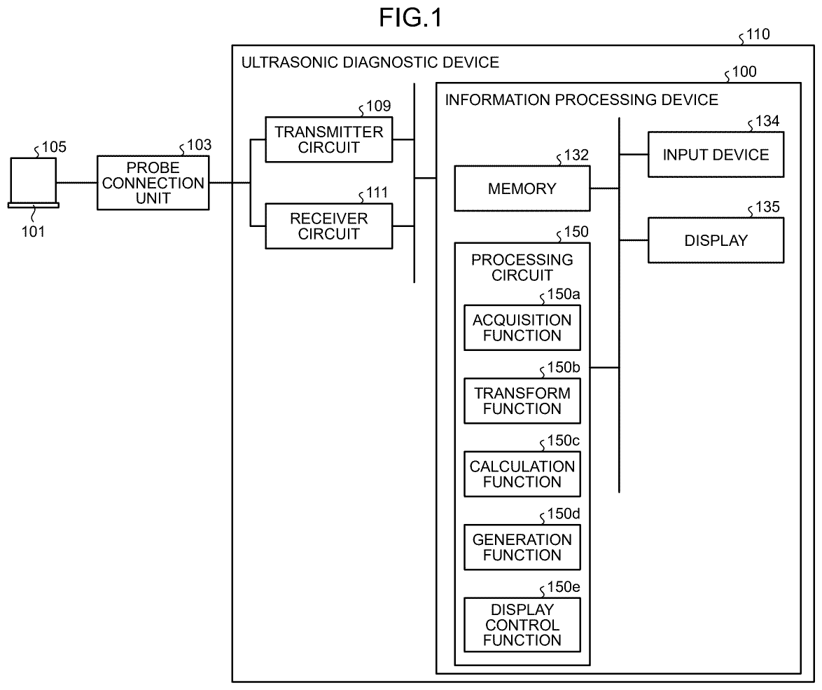

FIG. 1 is a block diagram illustrating a configuration of an ultrasonic diagnostic device according to an embodiment. An ultrasonic diagnostic device 110 is a device that generates ultrasonic data on the basis of a reception signal (reflected wave signal) received from an ultrasonic probe 105. The ultrasonic diagnostic device 110 illustrated in FIG. 1 is a device that can generate two-dimensional ultrasonic data on the basis of a two-dimensional reception signal, and that can generate three-dimensional ultrasonic data on the basis of a three-dimensional reception signal. However, the embodiment is also applicable even when the ultrasonic diagnostic device 110 is a device dedicated to two-dimensional data. The ultrasonic diagnostic device 110 includes a transmitter circuit 109, a receiver circuit 111, and an information processing device 100.

For example, the ultrasonic probe 105 is an electronic scanning type probe, and includes a plurality of transducer elements 101 that are arranged one-dimensionally or two-dimensionally at the tip end. The transducer elements 101 are piezoelectric elements (electromechanical conversion elements) that perform mutual conversion between electrical signals (voltage pulse signals) and ultrasonic waves (acoustic waves). The ultrasonic probe 105 transmits ultrasonic waves from the transducer elements 101 to a subject, and receives the reflected ultrasonic waves from the subject by the transducer elements 101. The reflected acoustic waves reflect the difference in acoustic impedance in the subject. When the transmitted ultrasonic pulse is reflected by the moving blood flow, the surface of the cardiac wall, or the like, due to the Doppler effect, the reflected ultrasonic waves depend on the velocity signal component with respect to the ultrasonic transmission direction of the moving body, and undergo a frequency shift.

A probe connection unit 103 is connected to the ultrasonic probe 105, and transmits and receives ultrasonic waves to and from the ultrasonic probe 105. The connection means between the ultrasonic probe 105 and the probe connection unit 103 may be either wired or wireless. In the case of wired, the probe connection unit 103 includes a connector unit (receptacle) to which the connector (plug) of the ultrasonic probe 105 is connected. In the case of wireless, the probe connection unit 103 includes a communication unit that performs wireless communication with the ultrasonic probe 105.

The transmission circuit 109 is a transmission unit that outputs pulse signals (drive signals) to the transducer elements 101. By applying pulse signals to the transducer elements 101 with a time difference, ultrasonic waves with different delay times are transmitted from the transducer elements 101. Hence, a transmission ultrasonic beam is formed. The direction and focus of the transmission ultrasonic beam can be controlled, by selectively changing the transducer element 101 to which the pulse signal is applied, and by changing the delay time (application timing) of the pulse signal. By sequentially changing the direction and focus of the transmission ultrasonic beam, an observation region in the subject is scanned. Moreover, the transmission ultrasonic beam that is a plane wave (focus is far) or a diffuse wave (focus point is opposite to the ultrasonic transmission direction with respect to the transducer elements 101) may be formed, by changing the delay time of the pulse signal. Alternatively, the transmission ultrasonic beam may be formed using one transducer element or a part of the transducer elements 101. By transmitting a pulse signal with a predetermined driving waveform to the transducer element 101, the transmitter circuit 109 generates a transmission ultrasonic wave having a predetermined transmission waveform at the transducer element 101.

The receiver circuit 111 is a reception unit that inputs the electrical signal output from the transducer element 101 that has received the reflected ultrasonic wave, as a reception signal. The reception signal is input to a processing circuit 150. In the present embodiment, an analog signal output from the transducer element 101 and digital data obtained by sampling (digitally converting) the analog signal are both referred to as a reception signal without any particular distinction. However, depending on the context, to clarify that the reception signal is digital data, the reception signal may be described as received data or measured data.

The information processing device 100 is connected to the transmitter circuit 109 and the receiver circuit 111, and processes the signal received from the receiver circuit 111, and controls the transmitter circuit 109. The information processing device 100 includes the processing circuit 150, a memory 132, an input device 134, and a display 135.

The memory 132 is configured by a semiconductor memory element such as a random access memory (RAM) and a flash memory, a hard disk, an optical disc, and the like. The memory 132 is a memory that stores data such as display image data generated by the processing circuit 150. Moreover, the memory 132 can store the reception signal (reflected wave signal) output from the receiver circuit 111. In addition, according to the need, the memory 132 stores a control program for performing ultrasonic transmission/reception, image processing, or display processing, and various data such as diagnostic information (for example, patient ID, doctor's observations, and the like), a diagnostic protocol and various body marks.

The input device 134 receives input of various instructions and information from an operator. For example, the input device 134 is configured by an input interface device such as a mouse, a keyboard, a button, and a trackball.

Under the control of the processing circuit 150, the display 135 displays a graphical user interface (GUI) for receiving input of imaging conditions, and various images. For example, the display 135 is configured by a display interface device such as a liquid crystal display.

The processing circuit 150 has an acquisition function 150a, a transform function 150b, a calculation function 150c, a generation function 150d, and a display control function 150e. In the embodiment, each processing function performed by the acquisition function 150a, the transform function 150b, the calculation function 150c, the generation function 150d, and the display control function 150e is stored in the memory 132 in the form of a computer-executable program. The processing circuit 150 is a processor that implements the function corresponding to each computer program, by reading a computer program from the memory 132 and executing the read computer program. In other words, the processing circuit 150 having read the computer programs has the functions indicated in the processing circuit 150 in FIG. 1. In FIG. 1, the processing functions performed by the acquisition function 150a, the transform function 150b, the calculation function 150c, the generation function 150d, and the display control function 150e are implemented by a single processing circuit 150. However, the processing circuit 150 may also be configured by combining a plurality of independent processors, and each processor may implement the function by executing the computer program. In other words, each of the functions described above may be configured as a computer program, and one processing circuit 150 may execute each computer program. As another example, a specific function may be implemented in a dedicated and independent program execution circuit. In FIG. 1, the acquisition function 150a, the transform function 150b, the calculation function 150c, the generation function 150d, and the display control function 150e are examples of an acquisition unit, a transform unit, a calculation unit, a generation unit, and a display control unit, respectively.

Moreover, for example, the term “processor” used in the above description refers to a central processing unit (CPU), a graphical processing unit (GPU), or a circuit such as an application specific integrated circuit (ASIC) and a programmable logic device (for example, a simple programmable logic device (SPLD), a complex programmable logic device (CPLD), and a field programmable gate array (FPGA)). The processor implements the function by reading and executing the computer program stored in the memory 132.

With the acquisition function 150a, the processing circuit 150 causes the ultrasonic probe 105 to perform ultrasonic scanning, and collects a plurality of pieces of frame data that are continuous in the time direction (a plurality of pieces of frame data within a predetermined time) obtained by ultrasonic scanning.

Moreover, the processing circuit 150 performs phase addition processing and quadrature detection processing on the reception signals (CH data) collected by a phase addition function and a quadrature detection function, which are not illustrated, via the receiver circuit 111. The phase addition processing is a process of adding the reception signals of the transducer elements 101 by changing the delay time and weight of each of the transducer elements 101, and is also referred to as a delay and sum (DAS) beamforming. The quadrature detection processing is a process of transforming the reception signal into a baseband in-phase signal and a quadrature signal (IQ data (measured data)). In addition, an adaptive beamforming, model-based processing, processing using machine learning, and the like may be performed on the reception signal.

Moreover, with the correction function, which is not illustrated, the processing circuit 150 may estimate the displacement amount of the tissue due to the body motion of a subject or the like between the pieces of frame data, and correct each frame data on the basis of the estimated results.

Furthermore, with the generation function 150d, the processing circuit 150 generates B-mode data (data in which the tissue-derived information is extracted or emphasized) in which the signal intensity at each point within the observation region is represented by luminance, by performing envelope detection processing, logarithmic compression processing, and the like. Still furthermore, with the generation function 150d, the processing circuit 150 generates blood flow data (power signal data) in which blood flow-derived information of the measured data is extracted or emphasized.

For example, with the correction function, which is not illustrated, the processing circuit 150 applies a moving target indicator (MTI) filter to the pieces of frame data. Consequently, the stationary tissue between the frames or slow moving tissue-derived information (tissue signal component (clutter)) is reduced, and the blood flow-derived information (blood flow signal component) is extracted. As the MTI filter, a filter having a fixed filter coefficient such as a Butterworth-type infinite impulse response (IIR) filter or a polynomial regression filter may be used. The MTI filter may also be an adaptive filter that changes the coefficient according to the input signal using eigenvalue decomposition, singular value decomposition, or the like.

Furthermore, by reading and executing the computer program stored in the memory 132, the processing circuit 150 functions the transform function 150b, the calculation function 150c, and the generation function 150d, and performs a process of outputting high-resolution ultrasonic data. The details of these processes will be described below. Still furthermore, with the display control function 150e, the processing circuit 150 displays the output high-resolution ultrasonic data on the display 135 serving as a display unit.

The processing circuit 150 may decompose the frame data into multiple bases by eigenvalue decomposition, singular value decomposition, or the like, remove the tissue-derived information by taking out a specific basis, and extract the blood flow-derived information. Moreover, by using a method such as a vector Doppler method, a speckle tracking method, and a vector flow mapping method, the processing circuit 150 may obtain the blood flow vector that represents the magnitude and direction of the blood flow, by obtaining the velocity vector of coordinates in the reception signal data. In addition to the methods illustrated in this example, any method may also be used as long as the method can extract or emphasize the blood flow-derived information, or remove or reduce the tissue-derived information included in the frame data (received data, measured data).

Subsequently, the background according to the embodiment will be described.

In the ultrasonic diagnosis, the structural information of blood vessels may be used for diagnosis. For example, to differentiate between benign and malignant tumors, a diagnosis may be made on the basis of information such as the number and thickness of blood vessels. During the process, a quantitative value representing structural information of blood vessels may be calculated. For example, a method of calculating a quantitative value representing structural information of blood vessels includes a method of calculating a quantitative value, after generating a binary image from an image obtained on the basis of the signal obtained by ultrasonic transmission/reception, and performing edge detection on the generated binary image.

In this example, to obtain the quantitative value representing structural information of blood vessels with high accuracy, the accuracy of binarization needs to be high. That is, the thickness and the number of blood vessels will not be calculated accurately, if the threshold value used for generating a binary image is too small or too large.

However, the accuracy of binarization may be reduced due to the variation in luminance in the image. As an example, when filter processing (wall filter processing) that removes a low-velocity signal is performed to remove a tissue component, during the generation of a blood flow image, the luminance of low-velocity blood flow is reduced by the filter processing. Hence, even if a common binary threshold value is used across the entire region, the accuracy may not be obtained. Thus, for example, after dividing the original data into each blood flow velocity, binarization processing may be performed on each blood flow velocity, and images to which the binarization processing is performed may then be combined. More generally, by taking into account a certain piece of basis information, the data may be classified by the basis information, the binarization processing may be performed on each basis information, and pieces of data may then be combined.

The embodiment is based on such an idea, and the information processing device 100 according to the embodiment includes the processing circuit 150. With the transform function 150b, the processing circuit 150 generates the second data that is a data array classified by the basis information by performing transform processing on the first data. With the calculation function 150c, the processing circuit 150 generates the third data including a plurality of pieces of data, by performing segmentation processing on the second data classified by the basis information. With the generation function 150d, the processing circuit 150 generates the fourth data by combining the pieces of data in the third data.

Moreover, the ultrasonic diagnostic device 110 according to the embodiment includes the processing circuit 150, and with the acquisition function 150a, the processing circuit 150 obtains the first data obtained on the basis of the transmission/reception of ultrasonic waves to and from the ultrasonic probe. Furthermore, the processing circuit 150 in the ultrasonic diagnostic device 110 performs the processes described above, with the transform function 150b, the calculation function 150c, and the generation function 150d.

Still furthermore, an information processing method according to the embodiment generates the second data that is a data array classified by basis information by performing transform processing on the first data, generates the third data including a plurality of pieces of data, by performing segmentation processing on the second data classified by the basis information, and generates the fourth data by combining the pieces of data in the third data. Still furthermore, a computer program according to the embodiment causes a computer to execute the processes described above.

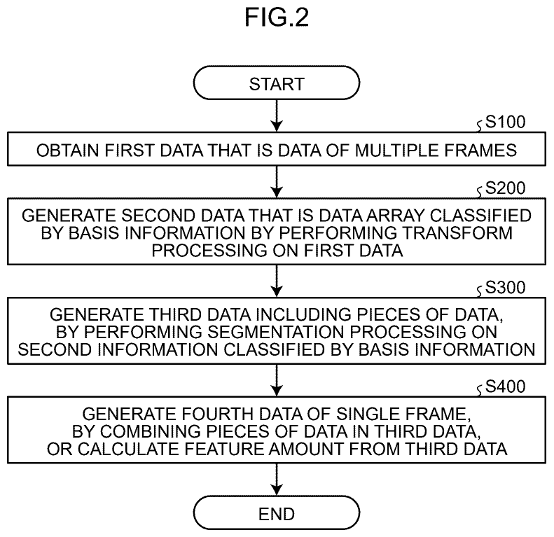

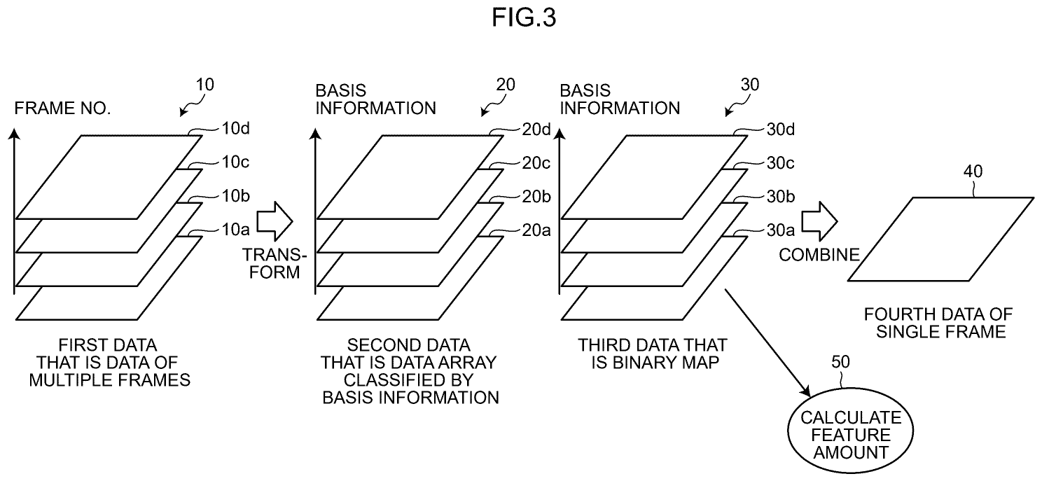

Such processes will be described with reference to FIG. 2 and FIG. 3. FIG. 2 is a flowchart for explaining a processing flow of the information processing device 100 according to the embodiment. FIG. 3 is a diagram for explaining the processing flow of the information processing device 100 according to the embodiment.

First, at step S100, with the acquisition function 150a, the processing circuit 150 obtains the first data obtained on the basis of the transmission/reception of ultrasonic waves to and from the ultrasonic probe. In this example, the first data obtained by the processing circuit 150 using the acquisition function 150a is data of multiple frames. As an example, as illustrated in FIG. 3, the processing circuit 150 obtains first data 10 that is data of multiple frames of frame data 10a, 10b, 10c and 10d, using the acquisition function 150a.

In other words, the ultrasonic diagnostic device 110 according to the present embodiment causes the ultrasonic probe to execute ultrasonic scanning, and collects the first data 10 that is pieces of frame data continuous in the time direction (pieces of frame data within a predetermined time) obtained by ultrasonic scanning. By executing ultrasonic scanning, the first data 10 that is the frame data is collected at a predetermined frame rate. In this example, the first data 10 that is the frame data refers to one of the received data, the measured data, the blood flow data, and the tissue data. For example, the received data is a reception signal (for example, CH data) of ultrasonic waves received by the ultrasonic probe. The measured data is data (for example, IQ data) obtained by performing phase addition processing and quadrature detection processing on the reception signal of the ultrasonic waves. The blood flow data is data (for example, power signal data) in which the blood flow-derived information of the measured data is extracted or emphasized, obtained by ultrasonic transmission/reception. The tissue data is data (for example, B-mode data) in which the tissue-derived information is extracted or emphasized.

For example, the measured data includes tissue-derived information (tissue signal component (clutter)) and blood flow-derived information (blood flow signal component). The blood flow-derived information may also include information derived from the contrast medium in the blood, in addition to the information derived from blood. Moreover, the blood flow data is data in which the blood flow-derived information is extracted or emphasized, and includes a velocity value, a dispersion value, and a power value of the blood flow.

For example, the extraction of the blood flow-derived information is an operation of taking out a blood flow signal component from the measured data. For example, the emphasis of the blood flow-derived information is an operation of highlighting the blood flow signal component relative to the tissue signal component. The blood flow data may be obtained by the process of extracting or emphasizing the blood flow-derived information, or may be obtained by the process of removing or reducing the tissue-derived information.

Subsequently, at step S200, with the transform function 150b, the processing circuit 150 generates the second data that is a data array classified by the basis information, by performing transform processing on the first data. In this example, the transform processing is a Fourier transform, for example, and a transform basis is a Fourier basis, for example. In this case, the second data generated at step S200 is a data array classified by the Fourier basis. In this example, when depicting the blood flow, the amount of the Fourier frequency corresponds to the blood flow velocity. Hence, in this case, the second data generated at step S200 is a data array classified by the blood flow velocity. As illustrated in FIG. 3, with the transform function 150b, the processing circuit 150 generates data 20a, 20b, 20c and 20d obtained for each basis information, on the basis of the frame data 10a, 10b, 10c and 10d. The data 20a, 20b, 20c and 20d configure second data 20.

Subsequently, at step S300, with the calculation function 150c, the processing circuit 150 generates third data 30 including pieces of data, by performing segmentation processing on the second data 20 classified by the basis information. As an example, with the calculation function 150c, the processing circuit 150 generates the third data 30 including pieces of data, by performing segmentation processing while creating a binary map from the second data 20. Specifically, as illustrated in FIG. 3, with the calculation function 150c, for each basis information, the processing circuit 150 generates the third data 30 including pieces of data, by performing segmentation processing while creating data 30a, 30b, 30c, and 30d that are each a binary map, from the data 20a, 20b, 20c, and 20d. The data 30a, 30b, 30c and 30d that are the binary maps, configure the third data 30.

Subsequently, at step S400, with the generation function 150d, the processing circuit 150 generates fourth data 40 by combining the third data 30. As an example, as illustrated in FIG. 3, with the generation function 150d, the processing circuit 150 generates the fourth data 40 by combining the binary maps 30a, 30b, 30c, and 30d. As an example, with the generation function 150d, the processing circuit 150 generates the fourth data 40, by counting, for each pixel, the number of times where values of the binary maps 30a, 30b, 30c, and 30d created for each basis information become equal to or greater than a threshold value, exceed the threshold value, become equal to or less than the threshold value, or become less than the threshold value. The reason for counting the number of times the binary map becomes equal to or greater than a threshold or the like for each pixel is because, when noise data and signal data are compared, the signal data constantly becomes equal to or greater than a threshold value or equal to or less than the threshold value regardless of the basis information, than the noise data. Therefore, by counting the number of times the binary maps 30a, 30b, 30c, and 30d created for each basis information using the generation function 150d, become equal to or greater than a threshold value, exceed the threshold value, become equal to or less than the threshold value, or become less than the threshold value for each pixel, the processing circuit 150 can reduce the contribution of the noise component. Hence, it is possible to improve the image quality.

Moreover, as another example of the method of combining the fourth data 40, as an example, with the generation function 150d, the processing circuit 150 generates the fourth data on the basis of the magnitude of fluctuation of the value of the third data (or second data) for each pixel, for the binary maps 30a, 30b, 30c, and 30d created for each basis information. As an example, with the generation function 150d, the processing circuit 150 generates the fourth data by extracting a pixel in which the magnitude of fluctuation of the value of the third data is smaller than a threshold value. For example, in a certain pixel, it is assumed that data of each frame is data corresponding to the velocity of “low velocity 1, low velocity 2, low velocity 3, high velocity 1, high velocity 2, and high velocity 3”, and in this example, it is assumed that the velocity is low velocity 1<low velocity 2<low velocity 3<high velocity 1<high velocity 2<high velocity 3. When data of “1, 1, 1, 0, 0, 0” is compared with data of “1, 0, 1, 1, 0, 1”, the former data is continuous and most likely a signal.

Alternatively, the latter data is not continuous and most likely noise. Thus, with the generation function 150d, the processing circuit 150 generates the fourth data on the basis of the magnitude of fluctuation of the value of the third data (or second data) created for each basis information.

At step S400, instead of generating the fourth data 40 using the generation function 150d, the processing circuit 150 may calculate a feature amount 50 from the third data 30 or the like. In this case, with the calculation function 150c, the processing circuit 150 calculates the feature amount 50 of an object, from the second data 20, the third data 30, or the fourth data 40. As an example, if the object is blood vessels, with the calculation function 150c, the processing circuit 150 calculates the blood vessel thickness, the blood vessel tortuosity, and the like from the second data 20, the third data 30, or the fourth data, as the feature amount of the blood vessel region.

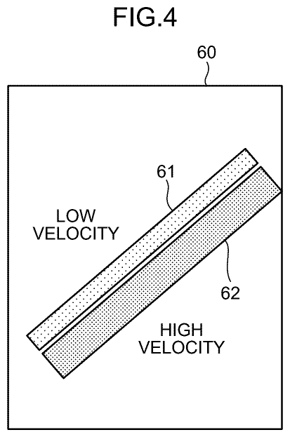

The effectiveness of the process of the information processing device 100 according to the embodiment is simulated. With reference to FIG. 4 to FIG. 6, these simulation results will be described.

In FIG. 4, an image 60 is the simulated original image. In the image 60, a region 61 is a region corresponding to a low-velocity blood flow region, and a region 62 is a region corresponding to a high-velocity blood flow region. By creating ultrasonic signal data of multiple frames that simulate a situation where the region 61 that is a low-velocity blood flow region and the region 62 that is a high-velocity blood flow region are present, the binarization processing and the noise removal processing are performed on the data, by the method according to the conventional technique and the method according to the embodiment.

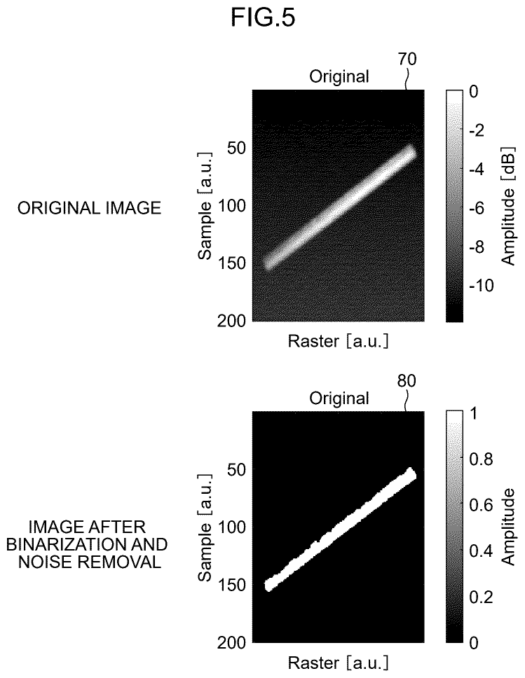

As a comparative example, FIG. 5 illustrates a case when the binarization processing and the noise removal processing are performed using the method according to the conventional technique. An image 70 is the original image, and an image 80 is an image from which noise is removed, after the binarization processing and the noise removal processing are performed using the conventional technique. In the comparative example, a certain amount of noise remains in the image after the noise is removed.

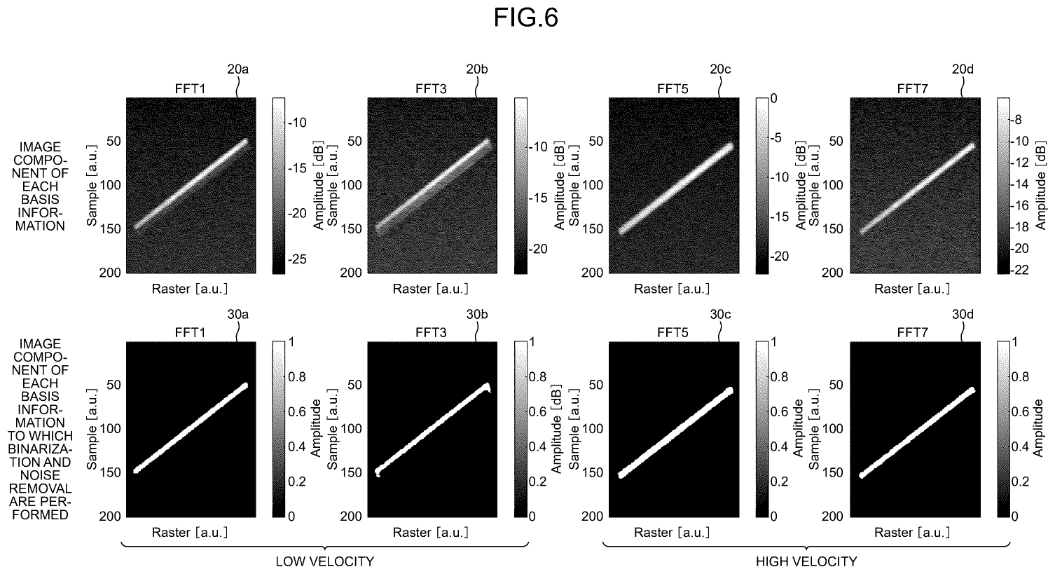

FIG. 6 illustrates the results when the binarization processing and the noise removal processing are performed using the method according to the embodiment, for each basis information. In the example of FIG. 6, the transform function 150b generates the second data from the first data using the Fourier transform, and the basis information is the Fourier basis. That is, in general, the basis information is information corresponding to the blood flow velocity.

In the upper row of FIG. 6, the data 20a, 20b, 20c, and 20d each represent the component of the second data for each basis information. The data 20a is an image corresponding to the basis information of the lowest frequency component, that is, the low velocity blood flow. The data 20b, 20c, and 20d each correspond to an image of the basis information of the high frequency component, that is, the high velocity blood flow, in this order.

Moreover, in the lower row of FIG. 6, the data 30a, 30b, 30c, and 30d each represent the data component to which the binarization and noise removal are performed, for each basis information. The data 30a is an image component corresponding to the basis information of the lowest frequency component, that is, the low-velocity blood flow.

The data 30b, 30c, and 30d each correspond to data of the basis information of the high frequency component, that is, the high velocity blood flow, in this order. In the method of the embodiment, the peak positions of the data 30a, 30b, 30c, and 30d differ for each basis information. Thus, in the embodiment, the high-velocity blood vessels and the low-velocity blood vessels are differentiated, and it is possible to change the threshold value of the binary mask according to the basis information. Consequently, it is possible to depict the blood vessel as appropriate.

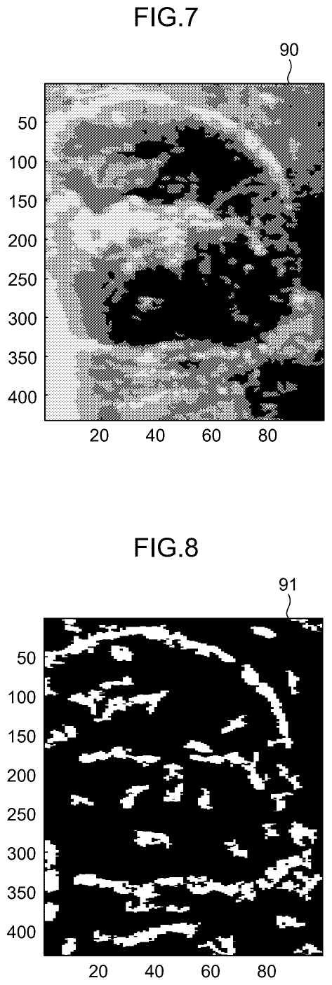

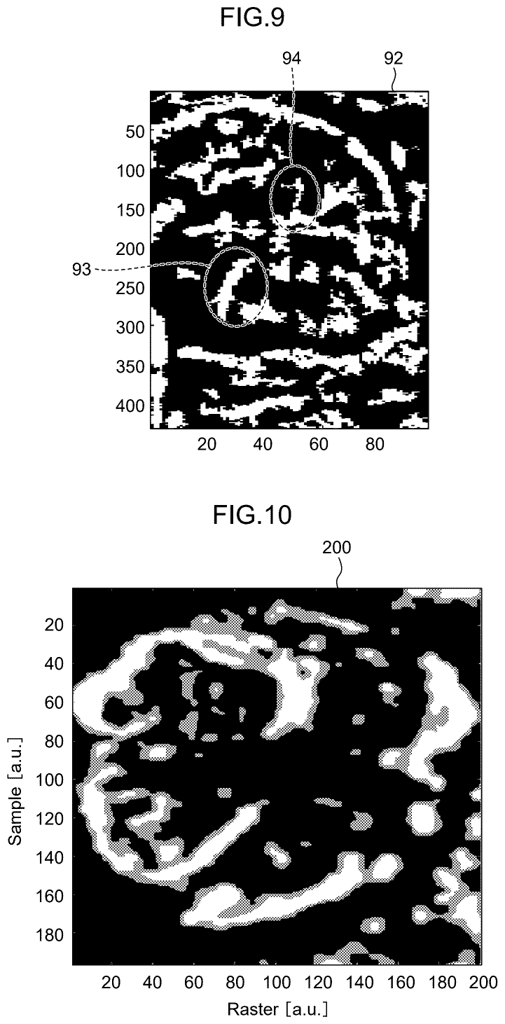

With reference to FIG. 7 to FIG. 9, an example of an image output by the information processing device 100 according to the embodiment will be described. FIG. 7 and FIG. 8 are images according to comparative examples. An image 90 in FIG. 7 is a first comparative example, and illustrates an image obtained by simply performing frame addition on the ultrasonic signals of the obtained frames. An image 91 in FIG. 8 is a second comparative example, and is an example of an output image when the binarization processing using an adaptive threshold value is performed on the image obtained by simply performing frame addition on the ultrasonic signals of the obtained frames. In contrast, an image 92 in FIG. 9 is a diagram illustrating an example of an output image output by the information processing device 100 according to the embodiment. In the image 92 in FIG. 9, the images are combined after the binary map is created for each basis information. Hence, for example, unlike the image 90 and the image 91, it is possible to clearly depict the structure such as a region 93 and a region 94 that cannot be depicted in the first comparative example and the second comparative example.

As described above, in the first embodiment, the processing circuit 150 generates the second data that is a data array classified by the basis information by performing transform processing on the first data, generates the third data by performing segmentation processing on each basis information and performing binarization, and then generates the fourth data by combining the pieces of data in the third data or calculates the feature amount from the third data. Consequently, it is possible to improve the accuracy of binarization processing, and improve the image quality.

### Other Embodiments

In the embodiment described above, as the basis information, the second data is a data array classified by the Fourier basis, and as a result, the basis information corresponds to the velocity of an object such as blood flow. However, the embodiment is not limited thereto. As an example, for the transformation of basis, Legendre transform, wavelet transform, and developments using various orthogonal bases such as spherical harmonic functions may also be used in addition to the Fourier transform, for example.

Moreover, as another example, the processing circuit 150 may perform the processes at step S200 to step S400, using information on the dispersion, direction, or displacement of an object as the basis information.

For example, if the second data is generated using the dispersion or displacement of an object as the basis information, the magnitude of dispersion/displacement in the frame direction of the first data becomes the basis information. In this case, at step S200, with the calculation function 150c, the processing circuit 150 divides the first data into a plurality of pieces of second data, according to the magnitude level of the dispersion/displacement of each pixel in the frame direction. As an example, with the calculation function 150c, the processing circuit 150 divides the first data into pieces of second data, according to the dispersion of the power value of the signal in the frame direction. Moreover, as another example, with the calculation function 150c, the processing circuit 150 divides the first data into pieces of second data, according to the variation amount of the tissue due to the body motion at each point and the like. At step S300, with the generation function 150d, the processing circuit 150 generates the third data that is a binary mask, by performing segmentation processing on the second information for each magnitude of dispersion/displacement in the frame direction that is the basis information. At step S400, with the generation function 150d, the processing circuit 150 generates the fourth data by combining the pieces of data in the third data, or with the calculation function 150c, calculates the feature amount from the third data.

Furthermore, for example, if the second data is generated using the direction of the object as the basis information, the direction of blood flow (running direction of blood vessels) becomes the basis information. As an example, the processing circuit 150 classifies the running direction of blood vessels into one of eight directions of directions of 0 degree, 45 degrees, 90 degrees, 135 degrees, 180 degrees, 225 degrees, 270 degrees, and 325 degrees. At steps S200 and S300, with the calculation function 150c, the processing circuit 150 generates the third data that is a binary mask separated in the blood flow direction (blood vessel direction), by classifying the blood vessels in the first data into one of the running directions, according to the blood flow direction (blood vessel direction) of the first data in each pixel, and by dividing the first data into a plurality of segments of second data. At step S400, with the generation function 150d, the processing circuit 150 generates the fourth data by combining the pieces of data in the third data, or with the calculation function 150c, calculates the feature amount from the third data.

Still furthermore, the selection of the basis information is not limited to the above example, and the processing circuit 150 may also classify the second data, by performing processing using the harmonic order in the ultrasonic transmission as the basis information. In this case, at step S100, for example, the type of the first data obtained by the processing circuit 150 using the acquisition function 150a is the received data, among the received data, the measured data, the blood flow data, and the tissue data. At step S200, with the calculation function 150c, the processing circuit 150 divides the first data into pieces of second data, according to the harmonic order in the ultrasonic transmission. At step S300, with the generation function 150d, the processing circuit 150 generates the third data that is a binary mask, by performing segmentation processing on the second information for each harmonic order in the ultrasonic transmission that is the basis information. At step S400, with the generation function 150d, the processing circuit 150 generates the fourth data by combining the pieces of data in the third data, or with the calculation function 150c, calculates the feature amount from the third data.

Moreover, the selection of the basis information is not limited to the above example, and at step S200, with the transform function 150b, the processing circuit 150 may generate the second data by dividing the first data on the basis of the structural information of an object obtained from the first data. As an example, if the object is blood vessels, at step S200, the processing circuit 150 obtains a power image that is blood flow data from the first data, calculates the structural information such as the blood vessel diameter on the basis of the obtained power image, and calculates an estimation value of the blood flow velocity on the basis of the calculated structural information. On the basis of the estimation value of the blood flow velocity calculated on the basis of the structural information such as the blood vessel diameter, the processing circuit 150 generates the second data by dividing the first data using the transform function 150b. In this case, the first data is not limited to data of multiple frames, but may also be data of a single frame.

Moreover, as a user interface according to the embodiment, with the display control function 150e, the processing circuit 150 may display an object determined as a different segment by the segmentation processing at step S300, on the display 135 serving as a display unit in a different color.

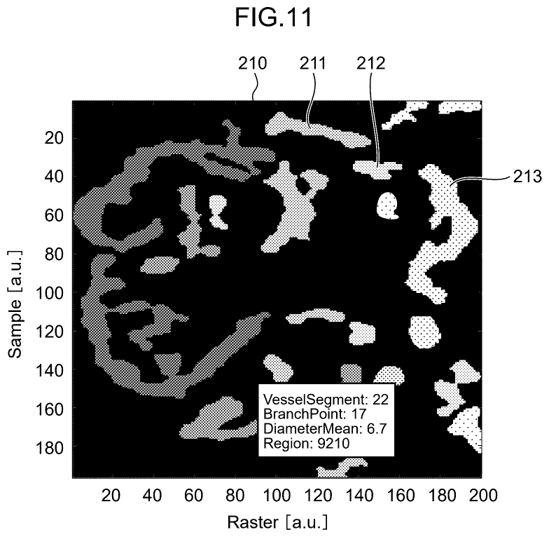

Such an example will be described with reference to FIG. 10 and FIG. 11. An image 200 in FIG. 10 is an example of an output image when the processing circuit 150 outputs the fourth data as a monochrome output image using the display control function 150e. In contrast, an image 210 in FIG. 11 is an example of an output image when the processing circuit 150 outputs the fourth data as a color image using the display control function 150e. In the image 210 that is a color image, regions 211, 212, and 213 with different blood flow velocities are recognized as separate sites, and displayed in different colors. Hence, the user can more easily recognize different sites.

Moreover, the user interface according to the embodiment is not limited to the above example. As an example, with the display control function 150e, the processing circuit 150 may display the third data and the fourth data in parallel on the display 135 serving as a display unit. For example, when the third data classified by the basis information, such as data for each blood flow velocity, and the combined fourth data are displayed in parallel on the display 135 serving as a display unit, the user can check the output image while checking the blood flow velocity, for example.

According to at least one of the embodiments described above, it is possible to improve the image quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
a processing circuit configured to
generate second data classified by basis information by performing transform processing on first data;
generate third data including a plurality of pieces of data, by performing segmentation processing on the second data classified by the basis information; and
generates fourth data by combining the pieces of data in the third data.

2. The information processing device according to claim 1, wherein the first data is data of multiple frames.

3. The information processing device according to claim 2, wherein the processing circuit is configured to generate the second data classified by a Fourier basis, by performing a Fourier transform on the first data.

4. The information processing device according to claim 1, wherein the first data is blood flow data obtained by ultrasonic transmission/reception.

5. The information processing device according to claim 1, wherein the processing circuit is configured to generate the third data by performing the segmentation processing by creating a binary map from the second data.

6. The information processing device according to claim 5, wherein, the processing circuit is configured to generate the fourth data, by counting, for each pixel, number of times where the binary map created for each basis information becomes equal to or greater than a threshold value, exceeds the threshold value, becomes equal to or less than the threshold value, or becomes less than the threshold value.

7. The information processing device according to claim 1, wherein the basis information is velocity of an object.

8. The information processing device according to claim 1, wherein the basis information is information of dispersion, direction, or displacement of an object.

9. The information processing device according to claim 1, wherein the basis information is harmonic order in ultrasonic transmission.

10. The information processing device according to claim 1, wherein the processing circuit is configured to calculate a feature amount of an object from the second data, the third data, or the fourth data.

11. The information processing device according to claim 1, wherein the processing circuit is configured to generate the fourth data based on magnitude of fluctuation of a value of the second data or the third data for each pixel.

12. The information processing device according to claim 1, wherein the processing circuit is configured to generate the second data by dividing the first data based on structural information of a blood vessel obtained from the first data.

13. The information processing device according to claim 1, wherein the processing circuit is configured to display an object determined as a different segment by the segmentation processing on a display unit in a different color.

14. The information processing device according to claim 1, wherein the processing circuit is configured to display the third data and the fourth data in parallel on a display unit.

15. An ultrasonic diagnostic device, comprising:
a processing circuit configured to
acquire first data obtained based on transmission/reception of an ultrasonic wave to and from an ultrasonic probe;
generate second data that is a data array classified by basis information by performing transform processing on the first data;
generate third data including a plurality of pieces of data, by performing segmentation processing on the second data classified by the basis information; and
generate fourth data by combining the pieces of data in the third data.

16. An information processing method, comprising:
generating second data that is a data array classified by basis information by performing transform processing on first data;
generating third data including a plurality of pieces of data, by performing segmentation processing on the second data classified by the basis information; and
generating fourth data by combining the pieces of data in the third data.

17. A non-transitory computer readable medium comprising instructions that cause a computer to execute:
generating second data that is a data array classified by basis information by performing transform processing on first data;
generating third data including a plurality of pieces of data, by performing segmentation processing on the second data classified by the basis information; and
generating fourth data by combining the pieces of data in the third data.
